(19) United States
(12) Patent Application Publication
(10) Pub. No.: US 2024/0403736 A1
(43) Pub. Date: Dec. 5, 2024

(54) SCHEDULING OPTIMIZATION METHOD AND SCHEDULING OPTIMIZATION SYSTEM

(71) Applicant: Mitsubishi Electric Corporation, Tokyo (JP)

(72) Inventor: Nobuyuki YOSHIKAWA, Tokyo (JP)

(73) Assignee: Mitsubishi Electric Corporation, Tokyo (JP)

(21) Appl. No.: 18/804,235

(22) Filed: Aug. 14, 2024

Related U.S. Application Data
(63) Continuation of application No. PCT/JP2022/017076, filed on Apr. 5, 2022.

(51) Int. Cl. G06Q 10/04

(52) U.S. Cl. CPC G06Q 10/04

(57) ABSTRACT

A scheduling optimization method includes: a step of generating an ising model for an occupation system to which at least one occupation subject and at least one occupation object belong, and for which an optimal solution of an order that the at least one occupation subject occupies the at least one occupation object, and of an occupation time; a step of calculating a plurality of solution candidates for the optimal solution by solving the ising model by an annealing method, each of the solution candidates indicating the order; a step of selecting a solution candidate that has a relatively small cost function and occurs relatively frequently among the plurality of solution candidates; and a step of assigning a time during which the at least one occupation subject occupies the at least one occupation object on the basis of the order indicated by the selected solution candidate.

### CROSS REFERENCE TO RELATED APPLICATIONS

This application is a Continuation of PCT International Application No. PCT/JP2022/017076, filed on Apr. 5, 2022, which is hereby expressly incorporated by reference into the present application.

### TECHNICAL FIELD

The present disclosure relates to a scheduling optimization method and a scheduling optimization system.

### BACKGROUND ART

An object of the runway optimization system that is described in Patent Literature 1 and is common to the scheduling optimization method according to the present disclosure in terms of optimization is to allow more airplanes to land and take off per unit time irrespectively of forms of runways. To achieve the above object, the above runway optimization system executes optimization calculation that minimizes a total sum of a plurality of runway occupation times corresponding to a plurality of airplanes that use a plurality of runways to obtain an optimal solution related to use of the plurality of runways by the plurality of airplanes.

### CITATION LIST

### Patent Literature

Patent Literature 1: JP 2014-041568 A

### SUMMARY OF INVENTION

### Technical Problem

However, even the above runway optimization system may require an enormous amount of a processing time taken to obtain the solution when solving, for example, an order optimization problem including a landing/takeoff order optimization problem or the like using a mathematical optimization method such as a Mixed Integer Programming (MIP) method. Furthermore, when the order optimization problem is solved using an ising model and an annealing method, the obtained solution may not have feasibility.

An object of the present disclosure is to provide a scheduling optimization method and a scheduling optimization system that can obtain a solution having feasibility, and reduce a processing time taken to obtain the solution compared to a conventional technique.

### Solution to Problem

To solve the above problem, a scheduling optimization method according to the present disclosure includes: generating an ising model for an occupation system to which at least one occupation subject and at least one occupation object belong, and for which an optimal solution of an order that the at least one occupation subject occupies the at least one occupation object, and of an occupation time during which the at least one occupation subject occupies the at least one occupation object is to be calculated; calculating a plurality of solution candidates for the optimal solution by solving the ising model by an annealing method, each of the solution candidates indicating the order that the at least one occupation subject occupies the at least one occupation object; selecting a solution candidate that has a relatively small cost function and occurs relatively frequently among the plurality of solution candidates; and assigning a time during which the at least one occupation subject occupies the at least one occupation object on a basis of the order indicated by the selected solution candidate and indicating that the at least one occupation subject occupies the at least one occupation object.

### Advantageous Effects of Invention

The scheduling optimization method according to the present disclosure can obtain a solution having feasibility, and reduce a processing time taken to obtain the solution compared to a conventional technique.

### BRIEF DESCRIPTION OF DRAWINGS

FIG. 1 illustrates a whole aspect including a scheduling optimization system SS according to an embodiment.

FIG. 2 is a functional block diagram of the scheduling optimization system SS according to the embodiment.

FIG. 3 illustrates time division of a runway KR1 according to the embodiment.

FIG. 4 illustrates a hardware configuration of the scheduling optimization system SS according to the embodiment.

FIG. 5 is a flowchart illustrating an operation of the scheduling optimization system SS according to the embodiment.

FIG. 6A illustrates initial assignment of the runway KR1 according to the embodiment.

FIG. 6B illustrates an initial total required time of the runway KR1 according to the embodiment.

FIG. 7A illustrates reassignment of the runway KR1 according to the embodiment.

FIG. 7B illustrates a total required time of the runway KR1 after reassignment according to the embodiment.

### DESCRIPTION OF EMBODIMENTS

An embodiment of a scheduling optimization system according to the present disclosure will be described.

### EMBODIMENT

### Embodiment

A scheduling optimization system SS according to the embodiment will be described.

Hereinafter, to facilitate description and understanding, one symbol represents a plurality of names in some cases, and, for example, one symbol “KK” represents a plurality of airplanes KK of airplanes KK1, KK2, KK3, and . . . .

### Whole Aspect of Embodiment

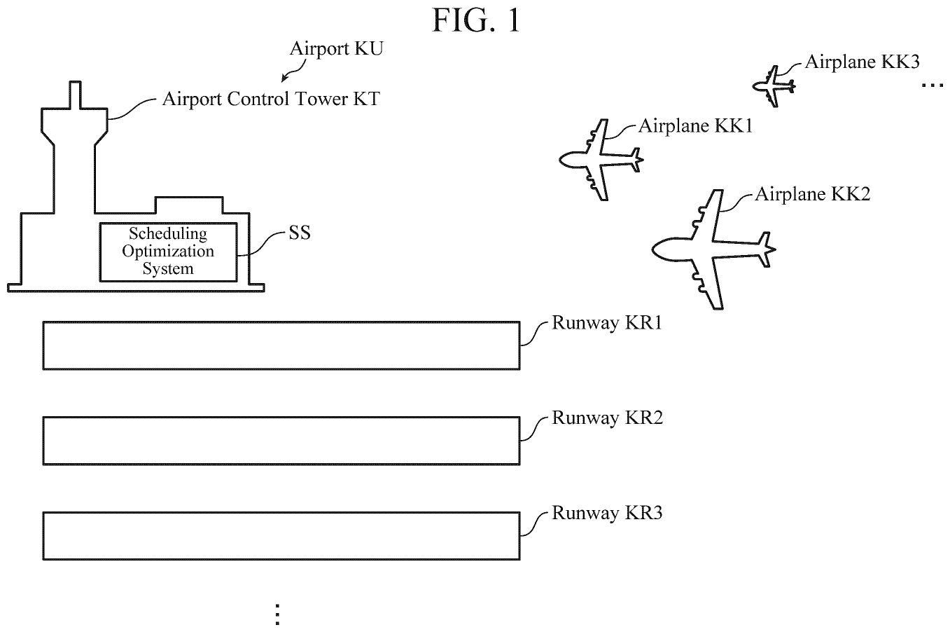

FIG. 1 illustrates the whole aspect including the scheduling optimization system SS according to the embodiment.

The scheduling optimization system SS according to the embodiment is provided in, for example, an airport control tower KT of an airport KU as illustrated in FIG. 1. The scheduling optimization system SS optimizes a landing/takeoff order schedule of the airplanes KK, and, for example, optimizes a schedule of an order that the airplanes KK1, KK2, KK3, and . . . land on runways KR1, KR2, KR3, and . . . in the airport KU.

The airplanes KK1, KK2, KK3, and . . . correspond to “occupation subjects”, the runways KR1, KR2, KR3, and . . . correspond to “occupation objects”, and the airport KU corresponds to an “occupation system”.

### Function of Embodiment

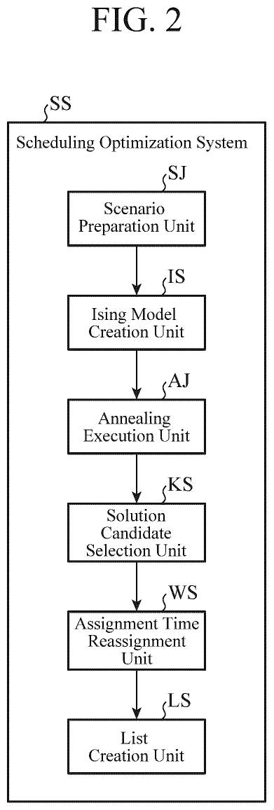

FIG. 2 is a functional block diagram of the scheduling optimization system SS according to the embodiment.

As illustrated in FIG. 2, the scheduling optimization system SS according to the embodiment includes a scenario preparation unit SJ, an ising model creation unit IS, an annealing execution unit AJ, a solution candidate selection unit KS, an assignment time reassignment unit WS, and a list creation unit LS.

The scenario preparation unit SJ prepares a scenario. More specifically, the scenario preparation unit SJ collects, for example, information such as (1) a time (hereinafter, referred to as an “assignable time”) during which the airplanes KK1, KK2, KK3, and . . . can be assigned to the runways KR1, KR2, KR3, and . . . , (2) an earliest time (hereinafter, referred to as an “earliest assignable time”) during which the airplanes KK1, KK2, KK3, and . . . can be assigned to the runways KR1, KR2, KR3, and . . . in the “assignable time”, (3) a latest time (hereinafter, referred to as a “latest assignable time”) during which the airplanes KK1, KK2, KK3, and . . . can be assigned to the runways KR1, KR2, KR3, and . . . in the “assignable time”, (4) a time (hereinafter, referred to as an “occupation time”) during which the airplanes KK1, KK2, KK3, and . . . use, that is, occupy the runways KR1, KR2, KR3, and . . . , (5) a time (hereinafter, referred to as an “inter-airplane time”) that needs to be provided between the occupation times of the airplanes KK1, KK2, KK3, and . . . from a viewpoint of safety, and the like.

Here, a time other than the “assignable time” is referred to as a “non-assignable time”.

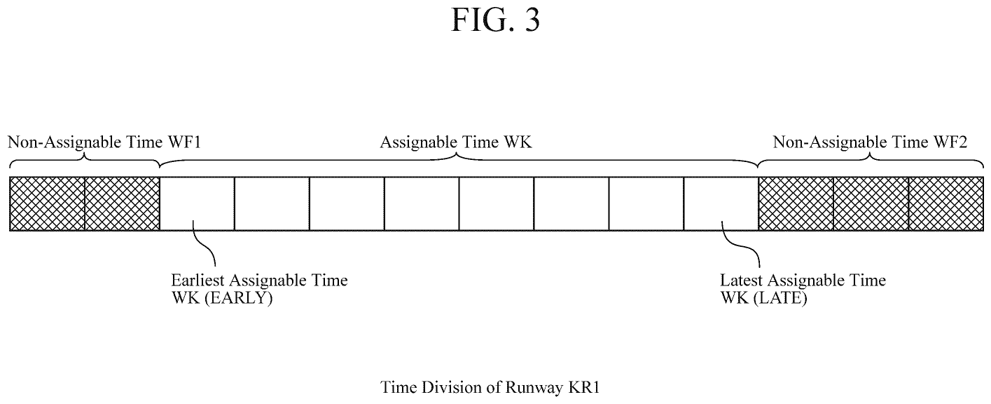

FIG. 3 illustrates time division of the runway KR1 according to the embodiment.

As illustrated in FIG. 3, a time of the runway KR1 is divided into a non-assignable time WF1, an assignable time WK, and a non-assignable time WF2.

An earliest assignable time WK (EARLY) is an earliest time during which at least one airplane of the airplanes KK1, KK2, KK3, and . . . can arrive at the runway KR1.

A latest assignable time WK (LATE) is a latest time during which at least one airplane of the airplanes KK1, KK2, KK3, and . . . can arrive at the runway KR1.

The non-assignable time WF1 is a time earlier than the earliest assignable time WK (EARLY), and is a time during which the airplanes KK1, KK2, KK3, and . . . cannot be assigned to the runway KR1.

The non-assignable time WF2 is a time later than the latest assignable time WK (LATE), and is a time during which the airplanes KK1, KK2, KK3, and . . . cannot be assigned to the runway KR1.

The scheduling optimization system SS can assign one or more of the airplanes KK1, KK2, KK3, and . . . to the assignable time WK of the runway KR1.

Back to FIG. 2, description continues.

The ising model creation unit IS creates an ising model for the airport KU (illustrated in FIG. 1). The ising model is a model for calculating an optimal solution of an order that at least one of the airplanes KK1, KK2, KK3, and . . . (illustrated in FIG. 1) occupies at least one of the runways KR1, KR2, KR3, and . . . , and of an occupation time during which the at least one of the airplanes occupies the at least one of the runways.

More specifically, the ising model creation unit IS creates, for example, the model obtained by multiplying (1) the number of the airplanes KK1, KK2, KK3, and . . . , (2) assignable times WK of the runways KR1, KR2, KR3, and . . . (illustrated in FIG. 3), and (3) the number of the runways KR1, KR2, KR3, and

The annealing execution unit AJ solves the above-described ising model. More specifically, the annealing execution unit AJ derives solution candidates of the ising model using, for example, a quantum annealer, a quantum annealer simulator, a simulated annealing, or the like.

The solution candidate selection unit KS selects one solution candidate that has a smallest cost function and occurs the most frequently among one or more solution candidates obtained by the annealing execution unit AJ.

Here, as for of the airplanes KK1, KK2, KK3, and . . . , the “cost function” is a square of a difference between the earliest assignable times WK (EARLY) of the airplanes KK1, KK2, KK3, and . . . , and time candidates to be assigned to the airplanes KK1, KK2, KK3, and . . . , and, more specifically, is obtained by adding a square of a difference between the earliest assignable time WK (EARLY) of the airplane KK1 and a time candidate to be assigned to the airplane KK1, a square of a difference between the earliest assignable time WK (EARLY) of the airplane KK2 and a time candidate to be assigned to the airplane KK2, a square of a difference between the earliest assignable time WK (EARLY) of the airplane KK3 and a time candidate to be assigned to the airplane KK3, . . . .

The “frequency” is a statistical probability that each solution candidate occurs.

In accordance with an order indicated by the solution candidate selected by the solution candidate selection unit KS and indicating that the airplanes KK1, KK2, KK3, and . . . should land on the runways KR1, KR2, KR3, and . . . , the assignment time reassignment unit WS reassigns a time during which the airplanes KK1, KK2, KK3, and . . . occupy the runways KR1, KR2, KR3, and . . . , for example, a time at which occupation starts and a time at which the occupation ends or a time at which occupation starts and a time during which the occupation continues.

### Hardware Configuration According to Embodiment

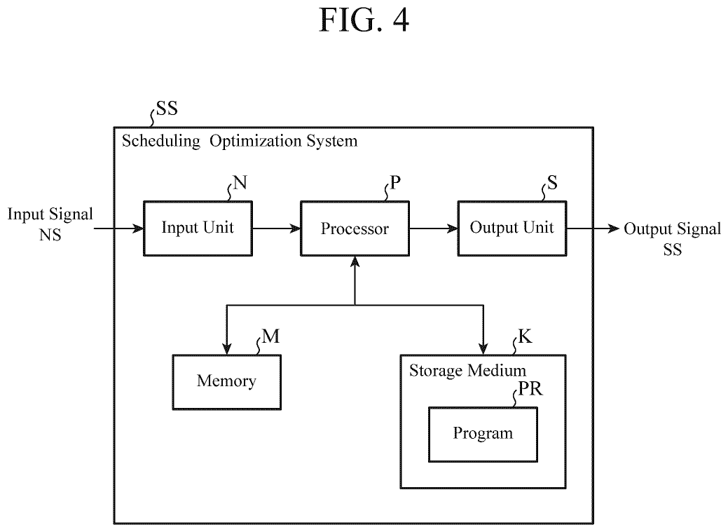

FIG. 4 illustrates the hardware configuration of the scheduling optimization system SS according to the embodiment.

In order to exhibit the above-described function (illustrated in FIG. 2), as illustrated in FIG. 4, the scheduling optimization system SS according to the embodiment includes a processor P, a memory M, and a storage medium K, and further includes an input unit N and an output unit S as needed.

The processor P is a well-known core of a computer that causes hardware to operate in accordance with software. The memory M is configured by, for example, a Dynamic Random Access Memory (DRAM) or a Static Random Access Memory (SRAM). The storage medium K is configured by, for example, a Hard Disk Drive (HDD), a Solid State Drive (SSD), or a Read Only Memory (ROM). The storage medium K stores a program PR. The program PR is an instruction group that defines contents of processing should be executed by the processor P.

The input unit N and the output unit S are configured by, for example, an input interface and an output interface that exchange an input signal NS and an output signal SS related to the operation of the processor P to and from the outside of the scheduling optimization system SS.

As for a relationship between the functions and the hardware configuration of the scheduling optimization system SS, the processor P executes on the hardware the program PR stored in the storage medium K using the memory M, and controls operations of the input unit N and the output unit S as needed, thereby implementing the function of each of the units from the scenario preparation unit SJ to the list creation unit LS (illustrated in FIG. 2).

### Operation According to Embodiment

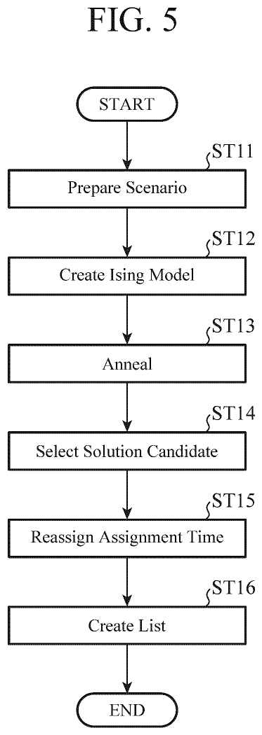

FIG. 5 is a flowchart illustrating an operation of the scheduling optimization system SS according to the embodiment.

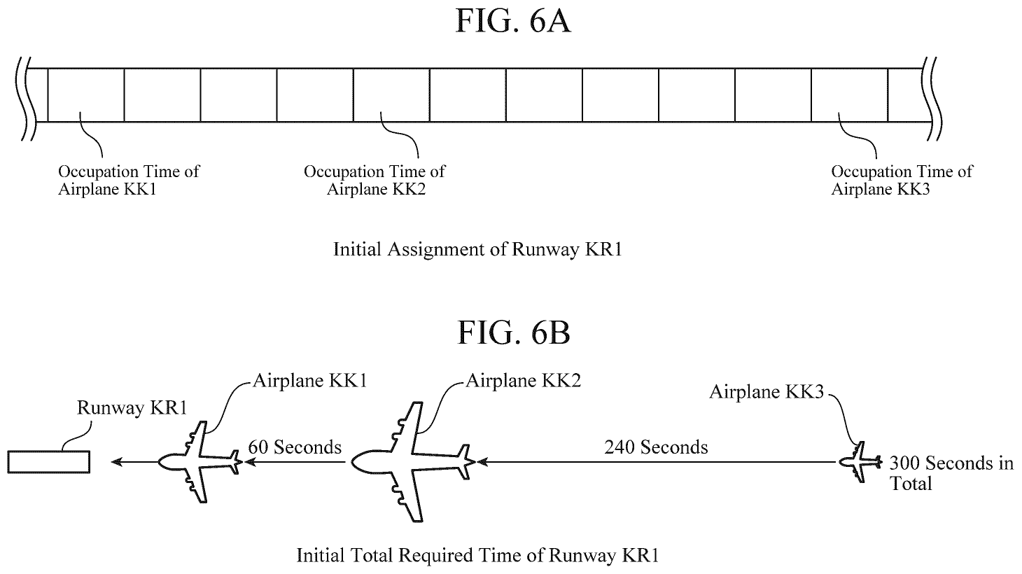

FIG. 6 illustrates initial assignment and an initial total required time of the runway KR1 according to the embodiment.

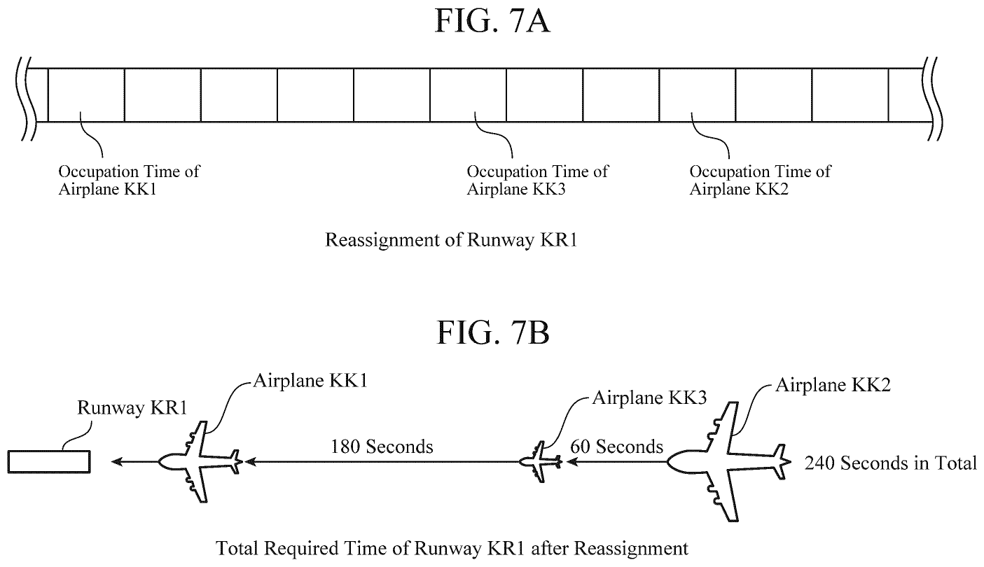

FIG. 7 illustrates reassignment and a total required time of the runway KR1 after reassignment according to the embodiment.

Hereinafter, to facilitate description and understanding, it is assumed that, for example, (1) when only three airplanes, that is, only the airplanes KK1, KK2, and KK3 (illustrated in FIG. 1) land only on one runway KR, that is, the runway KR1 (illustrated in FIG. 1), occupation times of the airplanes KK1, KK2, and KK3 are assigned to the runway KR1, (2) the occupation times of the airplanes KK1, KK2, and KK3 are identical, and (3) the occupation time of the airplane KK2 needs an inter-airplane time “60 seconds” or more apart from the last occupation time of the airplane KK.

In addition to above (1) to (3), it is also assumed that (4) at a time of initial assignment, in other words, before reassignment to be described later, the occupation times of the airplanes KK1, KK2, and KK3 are assigned to the runway KR1 in accordance with an arrival order “airplane KK1->airplane KK2->airplane KK3” as illustrated in FIG. 6A. Thus, it is assumed that (5) a total required time taken until all of the airplanes KK1, KK2, and KK3 finish arriving at the runway KR1 is initially “300 seconds” as illustrated in FIG. 6B.

Step ST11: The scenario preparation unit SJ (illustrated in FIG. 2) prepares a scenario. More specifically, as illustrated in FIG. 3, the scenario preparation unit SJ acquires information of the runway KR1 such as the earliest assignable times WK (EARLY) and the latest assignable times WK (LATE) of the airplanes KK1, KK2, and KK3, the occupation times of the airplanes KK1, KK2, and KK3, and the inter-airplane times between the occupation times of the airplanes KK1, KK2, and KK3.

Step ST12: The ising model creation unit IS (illustrated in FIG. 2) creates the ising model for the airport KU. More specifically, the ising model creation unit IS creates the model obtained by multiplying (1) the number of the airplanes KK1, KK2, and KK3 (illustrated in FIG. 1), (2) the assignable time WK (illustrated in FIG. 3) of the runways KR1 (illustrated in FIG. 3), and (3) the number of the runways KR1.

Step ST13: The annealing execution unit AJ (illustrated in FIG. 2) solves the ising model created by the ising model creation unit IS. The annealing execution unit AJ acquires one or more solution candidates by solving the ising model.

Step ST14: The solution candidate selection unit KS (illustrated in FIG. 2) selects a solution candidate that has a smaller cost function and occurs more frequently among the one or more solution candidates acquired by the annealing execution unit AJ.

Here, it is assumed that the arrival order of the airplanes KK indicated by the selected solution candidate is “airplane KK1->airplane KK3->airplane KK2” instead of the arrival order “airplane KK1->airplane KK2->airplane KK3” (illustrated in FIG. 6A) in the above assumption (4).

Step ST15: In accordance with the arrival order “airplane KK1->airplane KK3->airplane KK2” indicated by the above selected solution candidate, and the inter-airplane times of the airplanes KK1, KK2, and KK3 such as the inter-airplane time “60 seconds” or more in the above assumption (3), the assignment time reassignment unit WS (illustrated in FIG. 2) reassigns the occupation times of the airplanes KK1, KK2, and KK3 to the runway KR1. As a result, as illustrated in FIG. 7A, the occupation times of the airplanes KK1, KK2, and KK3 are reassigned to the runway KR1. As a result, the total required time taken until the airplanes KK1, KK2, and KK3 finish arriving at the runway KR1 is “240 seconds” as illustrated in FIG. 7B, and, in other words, the initial total required time in the above assumption (5) is reduced by 60 seconds from “300 seconds”.

Step ST16: The list creation unit LS (illustrated in FIG. 2) creates a list (not illustrated) obtained by the assignment time reassignment unit WS by reassigning the occupation times of the airplanes KK1, KK2, and KK3 to the runway KR in, for example, a format of an flight information board (a departure information board and an arrival information board) at a general airport.

### Effect According to Embodiment

As described above, in the scheduling optimization system SS according to the embodiment, the ising model creation unit IS creates the ising model, the annealing execution unit AJ solves the ising model, and the assignment time reassignment unit WS reassigns the occupation times of the airplanes KK1, KK3, and KK2 to the runway KR1 in accordance with the order of the airplanes KK1, KK2, and KK3 indicated by a solution obtained by solving the ising model. Consequently, as is clear from comparison between FIGS. 6A and 7A, it is possible to reduce the total required time taken until the airplanes KK1, KK2, and KK3 finish arriving at the runway KR1.

### Modified Example

Instead of selecting one solution candidate that has the above smallest cost function and occurs the most frequently among one or more solution candidates, the solution candidate selection unit KS selects a plurality of solution candidates that have relatively small cost functions and occur relatively more frequently, and present the plurality of selected solution candidates to a user of the scheduling optimization system SS, and the user may narrow down one or more solution candidates from the plurality of solution candidates.

It is possible to modify any components in the embodiment, or omit any components in the embodiment.

### Industrial Applicability

The scheduling optimization method according to the present disclosure can be used to obtain a solution having feasibility and reduce a processing time taken to obtain the solution.

### REFERENCE SIGNS LIST

AJ: annealing execution unit, IS: ising model creation unit, KK: airplane, KR: runway, KS: solution candidate selection unit, KT: airport control tower, KU: airport, LS: list creation unit, SJ: scenario preparation unit, SS: scheduling optimization system, WF1: non-assignable time, WF2: non-assignable time, WK: assignable time, WK (EARLY): earliest assignable time, WK (LATE): latest assignable time, WS: assignment time reassignment unit

1. A scheduling optimization method comprising:
generating an ising model for an occupation system to which at least one occupation subject and at least one occupation object belong, and for which an optimal solution of an order that the at least one occupation subject occupies the at least one occupation object, and of an occupation time during which the at least one occupation subject occupies the at least one occupation object is to be calculated;
calculating a plurality of solution candidates for the optimal solution by solving the ising model by an annealing method, each of the solution candidates indicating the order that the at least one occupation subject occupies the at least one occupation object;
selecting a solution candidate that has a relatively small cost function and occurs relatively frequently among the plurality of solution candidates; and
assigning a time during which the at least one occupation subject occupies the at least one occupation object on a basis of the order indicated by the selected solution candidate and indicating that the at least one occupation subject occupies the at least one occupation object.

2. A scheduling optimization system comprising:
a processer to execute a program; and
a memory to store the program which, when executed by the processor, performs, processes of,
generating an ising model for an occupation system to which at least one occupation subject and at least one occupation object belong, and for which an optimal solution of an order that the at least one occupation subject occupies the at least one occupation object, and of an occupation time during which the at least one occupation subject occupies the at least one occupation object is to be calculated;
calculating a plurality of solution candidates for the optimal solution by solving the ising model by an annealing method, each of the solution candidates indicating the order that the at least one occupation subject occupies the at least one occupation object;
selecting a solution candidate that has a relatively small cost function and occurs relatively frequently among the plurality of solution candidates; and
assigning a time during which the at least one occupation subject occupies the at least one occupation object on a basis of the order indicated by the selected solution candidate and indicating that the at least one occupation subject occupies the at least one occupation object.
